(19) United States
(12) Patent Application Publication
(10) Pub. No.: US 2006/0266952 A1
(43) Pub. Date: Nov. 30, 2006

(54) Automatic paper recognition method and device

(75) Inventor: Han Yi, Jiangsu (CN)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/437,614

(22) Filed: May 22, 2006

(30) Foreign Application Priority Data
May 24, 2005 (TW) 94116853

(51) Int. Cl. G01J 1/58

(52) U.S. Cl. 250/486.1

(57) ABSTRACT

An automatic paper recognition method. An infrared light source is provided on one side of a paper. The transmission infrared light is detected from the other side of the paper. Paper type is identified according to the detected transmission light intensity.

### BACKGROUND

The invention relates to automatic paper recognition, and more particularly, to methods and devices providing automatic paper recognition according to light transmission and reflection of printing medium.

Conventional printers require users to set the paper type for best printing results. Paper with finer surfaces is good for high density printing. Low density printing on a fine surface paper results in blank spaces between colors because ink in not absorbed. High density printing on normal paper results in unintentional color mixing by ink diffusion. Failure to set the correct print method corresponding to the paper type wastes expensive printing paper or ink.

A method of recognizing the paper type is disclosed by Samsung et al. in U.S. Pat. No. 5,633,670 “Thermal printing apparatus and method thereof”. Applicable in Thermal printers, the method uses a visible light source and photo sensor to detect reflection and transmission light from print media, distinguishing normal paper form OHP films. Since the transparency difference between normal paper and OHP film is significant, the method differentiates between the two media types without difficulty. For print media with transparency similar to normal paper, such as matte or glossy printer paper, however, the method cannot distinguish there between.

Another method of recognizing the paper type is disclosed by Walker, et al. in U.S. Pat. No. 6,425,650, “Educatable media determination system for inkjet printing”, in which the incoming media is optically scanned using a blue-violet light to obtain both diffusion reflection and specular reflection data, from which a media signature is generated. Obtaining both diffusion reflection and specular reflection data requires multiple lenses and logic circuits, however, increasing the costs of the system.

### SUMMARY

An automatic paper recognition method is provided, in which an infrared light source on one side of a media sheet. Transmission infrared light is detected from the other side of the paper. The type of media is identified accordingly.

An automatic paper recognition device using the method of the invention is also provided, which comprises a infrared light source; a first photo sensor detecting intensity of the transmission light of the infrared light source through a paper, and outputting a first light intensity signal; and a controller receiving the first light intensity signal, identifying the type of the paper according to the first light intensity signal and outputting a paper type signal.

A printer, using the automatic paper recognition device of the invention is further provided. The printer comprises a paper feeder; and an automatic paper recognition device receiving paper fed by the paper feeder. The automatic paper recognition device comprises a infrared light source; a first photo sensor detecting intensity of the transmission light of the infrared light source through a paper, and outputting a first light intensity signal; and a controller receiving the first light intensity signal, identifying the type of the paper according to the first light intensity signal and outputting a paper type signal.

### DESCRIPTION OF THE DRAWINGS

The accompanying drawings, incorporated in and constitute a part of this specification, illustrate embodiments of the invention and, together with the description, serve to explain the features, advantages, and principles of the invention.

FIG. 1 is a block diagram of a printer 10 according to an embodiment of the invention.

FIG. 2 is a schematic of an experimental circuit according to an embodiment of the invention.

### DETAILED DESCRIPTION

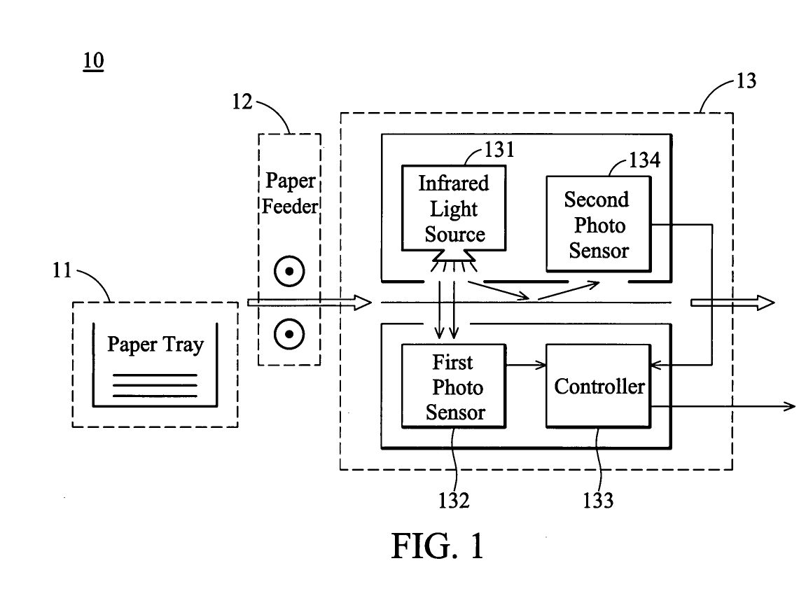

FIG. 1 is a block diagram of a printer according to an embodiment of the invention. Printer 10 comprises a paper tray 11, a paper feeder 12 and an automatic paper recognition device 13. Paper feeder 12 feeds a paper from paper tray 11 into the automatic paper recognition device 13 before printing.

Automatic paper recognition device 13 comprises an infrared light source 131, a first photo sensor 132 and a controller 133. Infrared light source 131 illuminates on one side of the paper, whereby infrared light is transmitted through the paper and received by the first photo sensor 132. Parts of the infrared light are reflected and attenuated, according to paper properties such as gloss, thickness or texture, etc.

First photo sensor 132 outputs a first light intensity signal corresponding to an intensity of the received infrared light to controller 133. Controller 133 receives the first light intensity signal and identifies the paper type according to voltage value thereof. Controller 133 can comprise an A-D converter (not shown) and logic circuit (not shown). The A-D converter receives a first light intensity signal and outputs digital values thereof to the logic circuit. Several sets of voltage ranges can be stored in the logic circuit, in each corresponding to a light intensity range measured by applying one type of paper in automatic paper recognition device 13. Paper ID is created according to each measured light intensity range. The logic circuit identifies the voltage range of which the digitized first light intensity signal is, and outputs a paper ID signal according to the voltage range.

The paper ID signal can be sent to a control unit (not shown) of the printer 10 for print optimization. The control unit of the printer 10 determines a printing method automatically using the paper ID signal, or sends a warning when the paper ID signal is incompatible with the current print method. Another warning can also be sent by controller 133 when a paper change is detected between two successive media feeds.

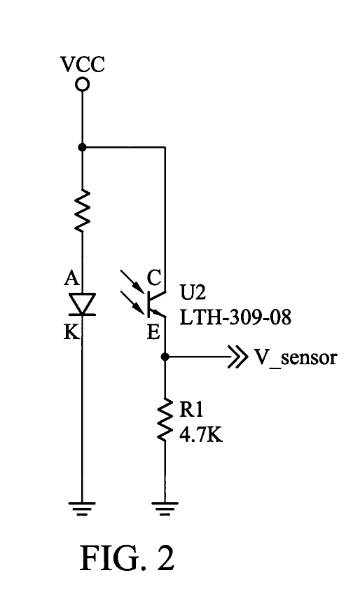

FIG. 2 is a schematic of an experimental circuit using Liteon LTH-309-08 infrared photo-interrupter according to an embodiment of the invention. Liteon LTH-309-08 infrared photo-interrupter is used as both a light source and photo sensor. Different types of paper are placed in the photo-interrupter and the output result of the experimental circuit is as listed:

| | | Sample 1 | | |
|---|---|---|---|---|
| Manufacturer | Type | (V) | Sample 2(V) | Sample 3(V) |
| Onhing | Regular 70 g | 1.8 | 1.83 | 1.82 |
| Kingdee | Regular 70 g | 1.86 | 1.82 | 1.8 |
| Kodak | Matte 95 g | 1.56 | 1.55 | 1.57 |
| Epson | Matte 95 g | 1.54 | 1.56 | 1.53 |
| Kodak | Glossy 173 g | 1 | 0.99 | 1.03 |
| Epson | Glossy 194 g | 0.98 | 1.02 | 0.99 |
| 3M | Transparency | 4.82 | 4.82 | 4.83 |

Wherein I_{C(ON)} = 8.036 mA, (I_{F} = 20 mA, V_{CE} = 5 V)

As listed in the table, similar type from different manufacturers has similar transmission light intensity, so that misjudgment of paper type can be prevented. Transmission light intensity difference between any two types of papers is obvious, therefore different light intensity ranges can be defined according to paper types without difficulty.

Misjudgment between a thinner paper with glossier surface and thicker paper with less glossy surface may occur due to similarities in transmission light intensity. A second photo sensor 134 is provided at the same side of the paper as infrared light source 131 to avoid such misjudgment. Second photo sensor 134 can be a phototransistor receiving a reflection light from the paper and outputting a second light intensity signal accordingly. Controller 133 receives the second light intensity signal for reference with the first light intensity signal and provides a more accurate result of the paper ID signal.

The invention discloses techniques that can automatically recognize paper type using a compact circuit design. The result is accurate and applicable in various user interfaces for improved print quality control.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. An automatic paper recognition method, comprising:
providing an infrared light source on one side of a paper;
detecting the transmission infrared light from the other side of the paper; and
identifying the type of the paper according to the detected transmitted light intensity.

2. The automatic paper recognition method as claimed in claim 1, further comprising:
detecting the reflection infrared light from the same side of the paper as the infrared light source, and
identifying the type of the paper further according to the detected reflection light intensity.

3. An automatic paper recognition device, comprising:
a infrared light source;
a first photo sensor detecting intensity of the transmission light of the infrared light source through a paper, and outputting a first light intensity signal; and
a controller receiving the first light intensity signal, identifying the type of the paper according to the first light intensity signal and outputting a paper type signal.

4. The automatic paper recognition device as claimed in claim 3, wherein the first photo sensor is a phototransistor.

5. The automatic paper recognition device as claimed in claim 3, wherein the controller comprises an A-D converter.

6. The automatic paper recognition device as claimed in claim 3, wherein a set of transmission light intensity ranges is stored in the controller, each range corresponding to a paper type.

7. The automatic paper recognition device as claimed in claim 3, further comprising a second photo sensor detecting intensity of the reflection light of the infrared light source from a paper, and outputting a second light intensity signal; the controller further receiving the second light intensity signal, identifying the type of the paper according to the first and second light intensity signals, and outputting a paper type signal.

8. The automatic paper recognition device as claimed in claim 7, wherein a set of transmission light intensity ranges and a set of reflection light intensity ranges are stored in the controller, each combination thereof corresponding to a paper type.

9. The automatic paper recognition device as claimed in claim 3, wherein the controller further outputs an alert signal when detecting a change in paper type signal data.

10. A printer comprising:
a paper feeder; and
an automatic paper recognition device receiving paper fed by the paper feeder, the automatic paper recognition device comprising:
a infrared light source;
a first photo sensor detecting intensity of the transmission light of the infrared light source through a paper, and outputting a first light intensity signal; and
a controller receiving the first light intensity signal, identifying the type of the paper according to the first light intensity signal and outputting a paper type signal.

11. The printer as claimed in claim 10, wherein a set of transmission light intensity ranges is stored in the controller, each range corresponding to a paper type.

12. The printer as claimed in claim 10, wherein further comprising a second photo sensor detecting intensity of the reflection light of the infrared light source from a paper, and outputting a second light intensity signal; the controller further receiving the second light intensity signal, identifying the paper type accordingly, and outputting a paper type signal.

13. The printer as claimed in claim 12, wherein a set of transmission light intensity ranges and a set of reflection light intensity ranges are stored in the controller, each combination thereof corresponding to a paper type.

14. The printer as claimed in claim 10, wherein the printer further comprises a controller receiving the paper type signal and automatically determining a print method using the paper ID signal.
